(19) United States
(12) Patent Application Publication
(10) Pub. No.: US 2005/0089726 A1
(43) Pub. Date: Apr. 28, 2005

(54) Magnetic recording medium and magnetic storage apparatus

(75) Inventor: E. Noel Abarra, Santa Clara, CA (US)

Correspondence Address: Patrick G. Burns, Esq.;GREER, BURNS & CRAIN, LTD., Suite 2500, 300 South Wacker Drive, Chicago, IL, 60606, US

(73) Assignee: FUJITSU LIMITED.

(21) Appl. No.: 10/952,017

(22) Filed: Sep. 28, 2004

Related U.S. Application Data
(63) Continuation of application No. PCT/JP02/03204, filed on Mar. 29, 2002.

(51) Int. Cl. G11B 5/64; B32B 1/00

(52) U.S. Cl. 428/694 TS; 428/336

(57) ABSTRACT

A magnetic recording medium is provided with at least two antiferromagnetically coupled magnetic layers on a VMn alloy underlayer on an amorphous-like seed layer. The underlayer may contain 55 at. % to 80 at. % V and the rest Mn. The seed layer may be made of the same material as the underlayer but reactively sputtered with N₂, an alloy of Cr and Ti where Cr is 25 at. % to 60 at. % and the remainder Ti reactively sputtered with N₂ or O₂, or a pure Ti seed layer reactively sputtered with N₂ or O₂. The combination of the seed layer and underlayer improves magnetic layer c-axis in-plane orientation essential for a Synthetic Ferrimagnetic Media (SFM).

This is a continuation application claiming the benefit of a PCT International Application No.PCT/JP2002/003204 filed Mar. 29, 2002, in the English language, in the Japanese Patent Office, the disclosure of which is hereby incorporated by reference.

The PCT International Application

No.PCT/JP2002/003204 was published under International Publication Number WO 03/083840 A1 in the English language on Oct. 9, 2003.

### BACKGROUND OF THE INVENTION

1. Field of the Invention

The present invention generally relates to magnetic recording media and magnetic storage apparatuses, and more particularly to a longitudinal magnetic recording medium having an underlayer and a seed layer for use with antiferromagnetically coupled magnetic layers on a substrate, and to a magnetic storage apparatus which uses such a magnetic recording medium.

2. Description of the Related Art

A typical longitudinal magnetic recording medium is made up of a substrate, a seed layer, a Cr or Cr alloy underlayer, a Co alloy magnetic layer where the information is written, a C overlayer, and an organic lubricant which are stacked in this order. Substrates that are being presently used include NiP-plated Al—Mg and glass. Glass substrates are becoming more popular due to their resistance to shock, smoothness, hardness, light weight, and minimum flutter especially at the disk edge.

The microstructure of the magnetic layer which includes grain size, size distribution, preferred orientation, and Cr segregation strongly affects the recording characteristics of the magnetic recording medium. The microstructure has widely been controlled by the use of seed layers and underlayers. Small grain size and size distribution with excellent crystallographic orientation are desired of such seed layers and underlayers.

Present day magnetic recording media have multiple layers below the magnetic layer to promote the necessary microstructure. For this reason, there can be confusion in the terms “seed layer” and “underlayer”. In this specification, the seed layer is defined as the layer close to the substrate which aid primarily in promoting a desired crystallographic orientation on the succeeding layers, which are usually underlayers, deposited on the seed layer. The seed layers are most likely amorphous such as the widely-used NiP. The underlayers are crystalline, mostly bcc such as Cr, and have either a (002), (110), or (112) fiber texture. In this specification, a crystalline film directly grown on the substrate, which develops a particular preferred crystallographic orientation is referred to as an underlayer.

The most extensively used underlayer has been Cr or Cr alloys such as CrMo, CrMn, CrV, CrTi, and CrW, where typically, the Cr content of the Cr alloy is at least 70 at. % and the additives are most often for enlarging the lattice parameter. The underlayers made of such materials are usually deposited on a mechanically textured or nontextured Ni₈₁P₁₉. Mechanical texturing invariably exposes NiP to air which oxidizes the film surface. Oxidation is important for the Cr to grow with a (002) texture which results in the subsequently deposited magnetic layer to have a (1120) crystallographic texture (or to use a different notation, [1120] preferred orientation). This is taken advantage of by a U.S. Pat. No. 5,866,227 to Chen et al. in which a reactively sputtered NiP (with O₂) seed layer on glass substrates is described. Typically, Cr is deposited at a temperature Ts which satisfies Ts>180° C. to promote a (002) texture with no (110) peak in the XRD spectrum. The Cr deposition at the temperature Ts which is low may result in smaller grains but a (110) texture is developed.

NiP does not adhere very well to glass, and thus, an adhesive layer such as that described by a U.S. Pat. No. 6,139,981 to Chuang et al. can be used. On NiP seed layers, underlayer grain sizes in the order of 8 nm to 10 nm can be realized by using two Cr alloy layers and by reducing the total underlayer thickness to less than 10 nm. Increasing the total underlayer thickness tends to significantly increase the average grain size. For example, for a single layer of Cr₈₀Mo₂₀, at a thickness t of t=30 nm, the average grain size can be approximately 20 nm which is obviously inadequate for present day media noise requirements. L. Tang et al., “Microstructure and texture evolution of Cr thin films with thickness”, J. Appl. Phys. vol.74, pp.5025-5032, 1993 also observed grain diameter increase with underlayer thickness. To achieve an average grain size less than 8 nm is difficult as further reduction of the underlayer thickness results in magnetic layer c-axis in-plane orientation (IPO) degradation. Although the underlayer average grain size can be small, a few large grains occasionally occur on which two or more magnetic grains may grow. The effective magnetic anisotropy of such grains may be reduced if magnetic isolation is not complete.

A U.S. Pat. No. 5,693,426 to Lee et al. describes ordered intermetallic underlayers with a B2 structure such as NiAl and FeAl. Ordered intermetallic alloys with structures such as B2, L₁₀, and L₁₂ are expected to have small grain sizes presumably due to the strong binding between the component atoms. Both NiAl and FeAl grow on glass substrates with a (211) fiber texture which makes the magnetic layer c-axis to be in-plane with a (1010) texture, as also discussed in Lee et al., “NiAl Underlayers For CoCrTa Magnetic Thin Films”, IEEE Trans. Magn., vol.30, pp.3951-3953, 1994 and Lee et al., “Effects of Cr Intermediate Layers on CoCrPt Thin Film Media on NiAl Underlayers”, IEEE Trans. Magn., vol.31, pp.2728-2730, 1995. Grain sizes in the order of 12 nm can be achieved even for thick layers having a thickness greater than 60 nm. The use of both NiAl and Cr on NiP has also been disclosed by a U.S. Pat. No. 6,010,795 to Chen et al. In this case, NiAl develops a (001) texture due to the (002) texture of the crystalline Cr “pre-underlayer” and the magnetic layer texture is Co(1120).

There are other seed layers aside from NiP that promote a Cr(002) texture. A U.S. Pat. No. 5,685,958 to Bian et al. describes refractory metals such as Ta, Cr, Nb, W, and Mo with a reactive element consisting of at least 1% nitrogen or oxygen. In the case of Ta, which is reactively sputtered with Ar+N₂ gas, as the N₂ volume fraction is increased, Cr (002) appears in the XRD spectrum as well as Co(1120). A typical underlayer thickness of 50 nm is mentioned in Bian et al. and wide variations in the thickness are described as only slightly affecting the media magnetic characteristics. As the volume fraction is increased to 3.3%, both peaks of the XRD spectrum disappear indicating the degradation of crystallographic orientation. Bian et al. proposed a useful range of substrate temperature Ts of 150° C. to 330° C., and a more preferred range of 210° C. to 250° C. This would make the substrate temperature Ts necessary for the deposition of the Cr onto Ta—N similar to that onto NiP. A useful range of nitrogen partial pressure of 0.1 mTorr to 2 mTorr is also suggested in Bian et al. The nitrogen concentration of the Ta—N films are unknown but may be between 10 at. % to 50 at. %.

Kataoka et al., “Magnetic and Recording Characteristics of Cr, Ta, W and Zr Pre-Coated Glass Disks”, IEEE Trans. Magn. vol.31, No.6, pp.2734-2736, 1995 which is cited in Bian et al. earlier reported Cr, Ta, W, and Zr pre-coating layers on glass. For Ta films, reactive sputtering with the proper amount of N₂ actually improves the succeeding Cr underlayer crystallographic orientation. Cr directly deposited on glass develops not only the preferred (002) orientation but also an undesirable (110) texture.

Oh et al., “A Study on VMn Underlayer in CoCrPt Longitudinal Media”, IEEE Trans. Magn. vol.17, No.4, pp.1504-1507 reported a VMn alloy underlayer, where the V content is 71.3 at. % and Mn is 28.7 at. %. The known CrV and CrMn underlayers tend to have a Cr content of 70 at. % to 90 at. %. The Cr proportion is made significant not only to achieve a desired lattice constant but to preserve the property of Cr to develop a (002) texture on amorphous seed layers such as NiP. V has a high melting point and in principle may grow with small grains when sputtered, but the texture is a very strong (110) on glass and on most seed layers.

Mn has a low melting point and has been considered as an underlayer only in combination with other metals as proposed in a U.S. Pat. No. 5,993,956 to Lambeth et al. CrMn and solid solutions of Mn alloys are utilized “to provide a template for epitaxial growth of the magnetic alloy and provide a source of Mn for diffusion to the grain boundaries of the Co alloy magnetic layer”. Included in the list of alloys is VMn. Although, no composition range was specified, V and Mn form a solid solution over a wide composition range. Lambeth et al. also disclosed polycrystalline seed layers such as MgO and a myriad of B2 materials such as NiAl and FeAl which form as “templates” for the succeeding Mn-containing alloys. VMn is expected to grow with the proper crystallographic texture depending on the template. However, no investigations were made on its fiber texture or in the use of VMn directly on amorphous seed layers to improve its (002) texture. The main feature of the patent is the advantageous effect Mn diffusion has on the noise properties of the magnetic layer.

On the other hand, Oh et al. described that when 30 nm of V_{71.3}Mn_{28.7} is grown directly on glass at the substrate temperature Ts of Ts=200° C. or 275° C., the preferred orientation is (002). However, there is a pronounced peak in the XRD spectrum corresponding to VMn(110) and CoCrPt(00.2) for the substrate temperature Ts of Ts=200° C. For the substrate temperature Ts of Ts=275° C., the VMn(110) disappears, and the CoCrPt(11.0) peak of the XRD spectrum is more intense compared to a CoCrPt/Cr medium directly on glass, which indicates that the IPO is better for the VMn underlayer case.

Even at a thickness of 30 nm, the V_{71.3}Mn_{28.7} grain sizes were significantly smaller (9.8 nm) than that of Cr (15.7 nm). However, Oh et al. found that diffusion is a problem in this alloy especially at Ts≧200° C. RBS analysis showed that not only Mn but also V diffused into the CoCrPt magnetic layer drastically reducing the magnetization. They rectified the problem by adding a layer of CrMo alloy between the VMn underlayer and the magnetic layer. Therefore, employed to take advantage of Mn diffusion is embodied in Lambeth et al., V_{71.3}Mn_{28.7} give rise to deleterious effects as significant V diffusion cannot be avoided. The Vanadium content of CrV underlayers is usually less than 25 at. % such that it does not adversely affect the properties of the magnetic layer compared to V-rich VMn alloys.

For NiAl (211) or VMn (002) underlayers on glass and Cr (002) on either NiP or TaN seed layers, the magnetic grain c-axes of the subsequently deposited magnetic layers are largely in the plane. However, the degree of alignment differs. Good IPO leads to an increase in the remanent magnetization and signal thermal stability. Good IPO also improves the resolution or capacity of the magnetic recording medium to support high-density bits.

Recently developed Synthetic Ferrimagnetic Media (SFM), such as that proposed in a Japanese Laid-Open Patent Application No.2001-56924, provide improved thermal stability and resolution compared to conventional magnetic recording media of the same remanent magnetization and thickness product Mrt. Seed layers that can be used for conventional magnetic recording media can also be used for SFM, but the potential of the SFM media for extending the limits of longitudinal magnetic recording can best be realized if the IPO is close to perfect. The IPO can be quantified by low incident angle XRD such as that made by Doerner et al., “Demonstration of 35 Gbits/in² in Media on Glass Substrates”, IEEE Trans. Magn. vol.37, No.2, pp.1052-1058, 2001 (for 10 Gbits/in² and 35 Gbits/in² demo) or more simply by taking the ratio h of the coercivity normal to and along the film plane. The ratio h is described by h=Hcl/Hc, where Hcl denotes the perpendicular coercivity, and Hc denotes the coercivity along the film plane.

The ratio h for media on Cr(002)/NiP is typically 0.15 or less and the ratio h greater than 0.2 is observed only for badly matched underlayers and magnetic layers. For h≦0.15, the M(H) hysteresis loop perpendicular to the film normal (perpendicular hysteresis loop) is approximately linear with field and the perpendicular coercivity Hcl is typically less than 500 Oe. In the case of NiAl, the (211) texture is weak and thicknesses greater than 50 nm are usually needed to realize it and reduce the occurrence of magnetic grains with a (0002) orientation. Previous work on using NiAl directly on glass as a seed layer for conventional media resulted in poor squareness (with h>0.25) and could not match the performance of the magnetic recording media having the Cr(002)/NiP structure. This is the case even when seed layers such as NiP and CoCrZr are employed. XRD measurements by Doerner et al. showed that the magnetic c-axes are spread over an angle greater than ±20° compared to less than ±5° for the magnetic recording media having the NiP/Al—Mg substrates. For the magnetic recording media having the Ta—N structure, though the Cr(002) and Co(1120) peaks are visible from the XRD data, h>0.2 and the magnetic recording media underperforms the magnetic recording media having the Cr(002)/NiP underlayer structure. The Cr alloy underlayer thickness used here is less than 10 nm; reduction of h was not observed by further increases in the underlayer thickness to >20 nm. But unlike B2 materials, and alloys such as VMn, the average grain diameter of Cr alloy underlayers rapidly increases with thickness. The IPO of the magnetic recording media having the V_{71.3}Mn_{28.7} underlayers on glass structure was not quantified by Oh et al., but investigations made by the present inventor show that the ratio h is greater than 0.15 even for a thickness t of 50 nm. Seed layers that lead to the reduction of the ratio h and limit the necessary VMn thickness to minimize underlayer grain lateral growth are therefore needed.

Aside from the IPO, another concern in the manufacturing of SFM is the increase in the number of chambers necessary compared to manufacturing conventional magnetic recording media especially when bare glass substrates are used. Moreover, as throughput has to be maintained at a high level, the thickness of the deposited film is limited to typically 30 nm. Seed layers or underlayers that need to be thicker will require two chambers. The typical sequential deposition must also be made in a rapid fashion not only to have a high yield but also to prevent the temperature of the high emissivity glass substrate to drop before the magnetic layers are deposited. Else, a heating step is needed which will require a separate process chamber. The substrate emissivity is decreased by the seed layer and the underlayer such that both cannot be very thin. If a bias voltage is to be applied as in CVD C deposition, the total medium thickness needed is usually greater than 30 nm.

### SUMMARY OF THE INVENTION

Accordingly, it is a general object of the present invention to provide a novel and useful magnetic recording medium and magnetic storage apparatus, in which the problems described above are eliminated.

The present invention provides a magnetic recording medium having a seed layer and an underlayer of small grain sizes and excellent in-plane orientation such that the ratio h is 0.15 or less, where h=Hc⊥/Hc, Hc⊥ denotes a perpendicular coercivity and Hc denotes a coercivity along the film plane, and to a magnetic storage apparatus which uses such a magnetic recording medium. The seed layer and the underlayer require only two chambers to be grown, and are of adequate thickness, to sufficiently improve the emissivity of the substrate. This is accomplished by the use of a reactively sputtered (with N₂ or O₂) amorphous-like seed layer such as CrxTi₁₀₀₋ₓ, where x=25 at. % to 60 at. %, Ta, and VyMn_{100-y}, where y=40 at. % to 80 at. % and a VxMn₁₀₀₋ₓ underlayer, where x=55 at. % to 80 at. %. The underlayer grows with a (002) texture on the seed layer which promotes an excellent (1120) crystallographic texture for magnetic layers grown above the underlayer.

In accordance with one aspect of the present invention, a magnetic recording medium comprises an amorphous or amorphous-like seed layer sputtered on a glass substrate, a VMn alloy underlayer deposited onto the seed layer, and a magnetic layer structure formed on the underlayer. The magnetic layer structure may be a multilayered synthetic ferrimagnetic structure of the Synthetic Ferrimagnetic Media (SFM).

In accordance with another aspect of the present invention, a magnetic recording medium comprises a glass substrate, a CrₓTi₁₀₀₋ₓ seed layer, where x=25 at. % to 60 at. %, a VₓMn₁₀₀₋ₓ underlayer, where x=55 at. % to 80 at. %, and a plurality of antiferromagnetically coupled magnetic layers. The magnetic recording medium has ratio h less than 0.15 which is better than magnetic layers on either Cr(002)/CrₓTi₁₀₀₋ₓ/Glass or on VₓMn₁₀₀₋ₓ directly deposited on glass.

In accordance with a further aspect of the present invention, a magnetic recording medium comprises a magnetic layer or a plurality of magnetic layers, a glass substrate, a VₓMn₁₀₀₋ₓ underlayer, where x=55 at. % to 80 at. %, and a reactively sputtered seed layer selected from a group consisting of CrₓTi₁₀₀₋ₓ, where x=25 at. % to 60 at. %, Ta, and V_{y}Mn_{100-y}, where y 40 at. % to 80 at. %. The sputtering gas is preferably a mixture of Ar and N₂ or Ar and O₂. The magnetic recording medium has a ratio h less than 0.15 which is better than magnetic layers on Cr(002)/CrₓTi₁₀₀₋ₓ—N/Glass, Cr(002)/Ta—N/Glass, or on VₓMn₁₀₀₋ₓ(002)/V_{y}Mn_{100-y}/Glass.

For x=25 at. % to 60 at. %, CrₓTi₁₀₀₋ₓ films reveal no peak in their XRD spectrum even without reactive sputtering with nitrogen or oxygen. Either they are amorphous or the grains are small and uncorrelated with each other. Ti—N films, depending on substrate temperature during deposition, sometimes exhibit a broad peak around 2θ=28° (λ=1.54) suggesting an amorphous structure. The other provided seed layers of the present invention also show no distinct XRD signature but the subsequent VₓMn₁₀₀₋ₓ film deposited on any of the seed layers exhibits a (002) peak, and the magnetic layer shows a distinct (1120) texture. The seed layer is preferably 20 nm to 30 nm thick and the VₓMn₁₀₀₋ₓ underlayer is preferrably 10 nm to 30 nm thick. The total thickness of the seed layer and underlayer is preferably 30 nm to 60 nm. This preferred range of thicknesses can be deposited in just two chambers and reduces the drop in glass substrate temperature during deposition of subsequent layers.

Another and more specific object of the present invention is to provide a magnetic recording medium comprising a glass substrate; an amorphous seed layer deposited directly on said substrate; a VₓMn₁₀₀₋ₓ underlayer where x=55 at. % to 80 at. % formed on said amorphous seed layer; and a CoCr alloy magnetic layer disposed on said underlayer, wherein c-axes of said magnetic layer is significantly parallel to a film plane thereof with a ratio h≦0.15, where h=Hc⊥/Hc, Hc⊥ denotes a perpendicular coercivity perpendicular to the film plane, and Hc denotes a coercivity along the film plane. According to the magnetic recording medium of the present invention, the VMn alloy underlayer on the seed layer promotes excellent IPO matching that of magnetic recording media on NiP.

In the magnetic recording medium, the magnetic layer may be made up of a synthetic ferrimagnetic structure having at least two antiferromagnetically coupled CoCr alloy magnetic layers wherein c-axes of the magnetic layers are significantly parallel to the film plane such that h≦0.15. The SFM has improved thermal stability but require excellent in-plane orientation, and according to the present invention, this is provided by the combination of the underlayer and the seed layer.

The underlayer may have a thickness of 10 nm to 30 nm. This range of thickness promotes excellent crystallographic orientation and not develop large grains.

The seed layer may be made of CrₓTi₁₀₀₋ₓ where x=25 at. % to 60 at. % and have a thickness of 20 nm to 30 nm. The seed layer may be sputtered in an Ar+N₂ or Ar+O₂ gas mixture with N₂ or O₂ partial pressure P of 1% to 8%. CrTi with N or O also promotes excellent crystallographic orientation for the VMn underlayer.

The seed layer may be made of Ta and have a thickness of 20 nm to 30 nm. The seed layer may be sputtered in an Ar+N₂ gas mixture with N₂ partial pressure P_{N}=3% to 9%. Ta-N promotes excellent crystallographic orientation for the VMn underlayer.

The seed layer may be made of V_{y}Mn_{100-y} where y=40 at. % to 80 at. % and have a thickness of 20 nm to 30 nm sputtered in an Ar+N₂ gas mixture with N₂ partial pressure P_{N}=1% to 8%. V_{y}Mn_{100-y}—N promotes excellent crystallographic orientation for the VMn underlayer.

A total thickness of the seed layer and the underlayer may be greater than 30 nm and less than 60 nm. These are preferred thicknesses to limit the number of chambers needed to deposit the two layers, provide enough coating to the glass substrate to reduce its emissivity and therefore reduce the rate of cooling, and adequate electrical conductivity for an effective C deposition by CVD with voltage biasing.

The seed layer may be deposited at a substrate temperature Ts of 50° C.<Ts<300° C. directly on the glass substrate. Due to the seed layer, the range of the substrate temperature Ts for the seed layer is expanded.

The seed layer may be made of NiP pre-coated on the glass substrate. NiP seed layer promotes an excellent crystallographic orientation for the VMn underlayer.

The magnetic recording medium may further comprise a Cr—M diffusion barrier layer having a thickness of 1 nm to 10 nm formed directly on the underlayer and disposed between the underlayer and the magnetic layer or synthetic ferrimagnetic structure, where M is a material selected from a group consisting of Mo, Ti, V, and W of atomic proportion greater than or equal to 10%. Cr-rich alloys adhere well to many types of materials such that it makes a good buffer layer between the underlayer and the magnetic layer. It prevents the diffusion of too much V into the magnetic layer. Since the Cr lattice parameter (a=0.2886 nm) is smaller than the VMn underlayer lattice parameter (a≧0.29 nm), it is advantageous to alloy Cr with a larger element such as those included in the above group.

The magnetic recording medium may further comprise an interlayer made of a slightly magnetic or nonmagnetic hcp structured CoCr alloy and having a thickness of 1 nm to 5 nm in direct contact with the magnetic layer or synthetic ferrimagnetic structure and disposed between the underlayer and the magnetic layer or synthetic ferrimagnetic structure. When HCP magnetic CoCr alloys are grown directly on BCC Cr alloy films, a portion of the magnetic layer in contact with the BCC underlayer is adversely affected due to lattice mismatch and or Cr or VMn diffusion. The magnetic layer magnetic anisotropy is reduced as well as the total magnetization. The use of an HCP non-magnetic interlayer prevents such effects to happen on the magnetic layer. As a result, the magnetic anisotropy is increased as well as the coercivity, the in-plane orientation is improved as this added layer provides a way to gradually match lattice parameters, and the full magnetization is obtained, i.e., the “dead layer” is minimized. Moreover, the formation of smaller grains at the interface is also minimized.

The magnetic recording medium may further comprise a protective layer made of C and having a thickness of 1 nm to 5 nm and an organic lubricant having a thickness of 1 nm to 3 nm. The C layer which may be deposited by CVD is hard and protects the magnetic recording medium not only from atmospheric degradation but also from the slider which carries the write head and read sensor. The lubricant reduces stiction between the slider and the magnetic recording medium.

A further object of the present invention is to provide a magnetic storage apparatus which uses at least one magnetic recording medium according to the present invention having any of the structures described above. The magnetic recording medium may be a magnetic disk.

Other objects and further features of the present invention will be apparent from the following detailed description when read in conjunction with the accompanying drawings.

### BRIEF DESCRIPTION OF THE DRAWINGS

FIG. 1 is a cross sectional view showing a layer structure of a first magnetic recording medium having a Cr underlayer and NiP seed layer;

FIG. 2 is a cross sectional view showing a layer structure of a second magnetic recording medium having a layer structure similar to FIG. 1 but with a plurality of antiferromagnetically coupled magnetic layers;

FIG. 3 is a cross sectional view showing a layer structure of a third magnetic recording medium having a V₇₀Mn₃₀ underlayer on glass;

FIG. 4 is a cross sectional view showing a layer structure of a fourth magnetic recording medium having a refractory metal seed layer;

FIG. 5 is a cross sectional view showing an important part of a first embodiment of a magnetic recording medium according to the present invention;

FIG. 6 is a cross sectional view showing an important part of a second embodiment of the magnetic recording medium according to the present invention;

FIG. 7 shows the XRD spectra of SFM on a V₇₅Mn₂₅ underlayer with CrₓTi₁₀₀₋ₓ seed layers;

FIGS. 8A through 8D show corresponding perpendicular hysteresis loops with respect to FIG. 7 for x=30 at. % to 60 at. %;

FIG. 9 is a plot showing XRD patterns for films with structure CO₆₉Cr₂₁Pt₈Ta₂/Cr₈₀Mo₂₀/VₓMn₁₀₀₋ₓ/Ta—N where x=36 at. % to 84 at. % on glass substrates;

FIGS. 10A through 10F are plots showing perpendicular hysteresis loops for the film structure used in FIG. 9 measured with a Kerr magnetometer;

FIG. 11 is a plot showing XRD patterns for films of structure CO₆₉Cr₂₁Pt₈Ta₂/Cr₈₀Mo₂₀/V₇₀Mn₃₀ with and without a Ta—N seed layer;

FIG. 12 is a plot showing the XRD patterns for the magnetic recording media with the structure CO₆₉Cr₂₁Pt₈Ta₂/Cr₈₀Mo₂₀/V₇₀Mn₃₀/Ta—N(P_{N}=8%) grown at different temperatures;

FIGS. 13A through 13C are plots showing the perpendicular hysteresis loops for the structure used in FIG. 12;

FIG. 14 is a plot showing the perpendicular coercivity Hc⊥ of media on V₇₀Mn₃₀/Ta—N for different nitrogen partial pressures and on V₇₀Mn₃₀/NiP;

FIGS. 15A and 15B are plots showing the in-plane and out-of-plane hysteresis loops of an SFM on V₇₅Mn₂₅;

FIGS. 16A and 16B are plots showing the in-plane and out-of-plane hysteresis loops of an SFM on V₇₅Mn₂₅/V₇₅Mn₂₅—N6%;

FIG. 17 is a plot showing the in-plane hysteresis loops of an SFM on Cr(002)/NiP and an SFM on V₇₅Mn₂₅(25 nm)/V₇₅Mn₂₅—N6% (25 nm);

FIGS. 18A and 18B are plots showing the perpendicular hysteresis loops of CoCrPtBCu media on V₅₇Mn₄₃/NiP with and without CrMo;

FIGS. 18C and 18D are plots showing the perpendicular hysteresis loops of CoCrPtTa media on V₅₇Mn₄₃/NiP with and without CrMo;

FIG. 19 is a cross sectional view showing an important part of an embodiment of a magnetic storage apparatus according to the present invention; and

FIG. 20 is a plan view of the magnetic storage apparatus shown in FIG. 19 with a top cover removed.

### DESCRIPTION OF THE PREFERRED EMBODIMENTS

Aluminum substrates with electroplated NiP has been widely used for many years. When grown at high substrate temperatures Ts>150° C., Cr alloy underlayers form the desirable (002) orientation. Sputtered NiP on glass has proven to be as effective in promoting the proper crystallographic orientation of Cr underlayers as disclosed in a U.S. Pat. No. 5,866,227 to Chen et al. Therefore, with the same seed layer, existing Al media technology can be used for the subsequent layers.

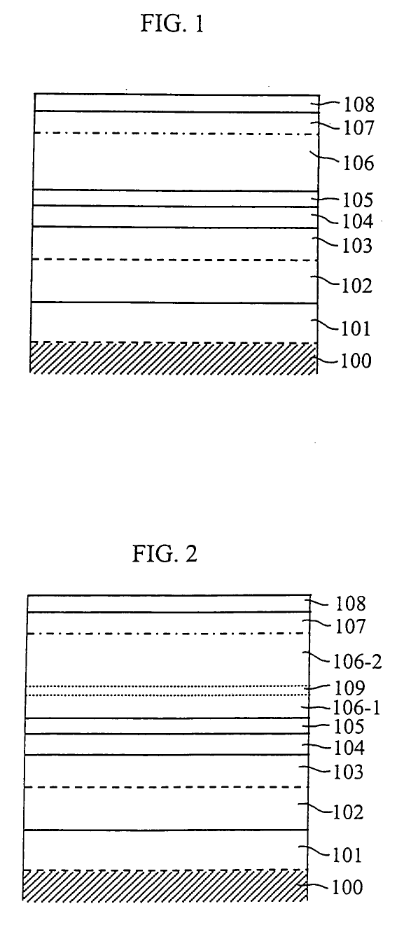

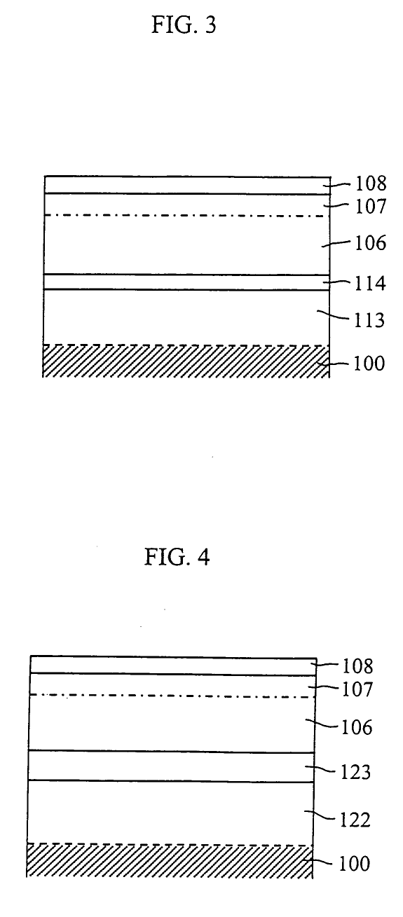

FIGS. 1 through 4 show cross sections of layer structures of various magnetic recording media for facilitating the understanding of a magnetic recording medium according to the present invention. FIG. 1 is a cross sectional view showing a layer structure of a first magnetic recording medium having a Cr underlayer and NiP seed layer. FIG. 2 is a cross sectional view showing a layer structure of a second magnetic recording medium having a layer structure similar to FIG. 1 but with a plurality of antiferromagnetically coupled magnetic layers. FIG. 3 is a cross sectional view showing a layer structure of a third magnetic recording medium having a V₇₀Mn₃₀ underlayer on glass. FIG. 4 is a cross sectional view showing a layer structure of a fourth magnetic recording medium having a refractory metal seed layer. In FIGS. 2 through 4, those parts which are the same as those corresponding parts in FIG. 1 are designated by the same reference numerals, and a description thereof will be omitted.

In FIG. 1, on a glass substrate 100 is formed an amorphous layer 102 of NiP. The NiP layer 102 is preferably oxidized. To enhance the adhesion of NiP to glass, elements such as Cr may be alloyed with NiP or a separate adhesive layer 101 consisting essentially of Cr may be provided between the substrate 100 and the NiP layer 102. On the NiP layer 102 is grown an underlayer made up of first and second underlayers 103 and 104 consisting essentially of Cr with a (002) texture on which a magnetic layer 106 is deposited. The second Cr underlayer 104 usually has a larger lattice parameter than the first Cr underlayer 103. The magnetic layer 106 has a (1120) crystallographic orientation, and may be made up of a single layer or two layers that are in direct contact and behave magnetically as one. An interlayer 105 made of a CoCr alloy may be disposed between the magnetic layer 106 and the second Cr underlayer 104. On the magnetic layer 106, a thin layer 107 of C and an organic lubricant layer 108 are successively deposited for use with a magnetic transducer such as a spin-valve head on a slider of a magnetic storage apparatus.

The layer structure shown in FIG. 2 is similar to that shown in FIG. 1, but the magnetic layer 106 is made up of a plurality of magnetic layers 106-1 and 106-2 that are antiferro-magnetically coupled through a spacer layer 109 made of Ru. For the two-layer SFM shown in FIG. 2, the first magnetic layer 106-1 functions as a stabilizing layer, and the second magnetic layer 106-2 functions as a main recording layer.

In FIG. 3, on the glass substrate 100 is formed a V_{71.3}Mn_{28.7} underlayer 113 on which a magnetic layer 106 is deposited. To prevent the diffusion of V and Mn into the magnetic layer 106, a CrMo alloy 114 may be disposed between the underlayer 113 and the magnetic layer 106.

Though Oh et al. reported primarily on the microstructure of VMn underlayers and not on read-write properties of media with VMn underlayers, the structure shown in FIG. 2 is its expected realization when used in a magnetic storage apparatus such as a magnetic disk drive.

FIG. 3 would also be similar to a medium as disclosed by Lambeth et al. except that the VMn alloy is situated such that adequate diffusion of Mn into the magnetic layer occurs. Direct contact with the magnetic layer is therefore preferred or layer 114 can be made very thin (<1 nm) to presumably control Mn diffusion. A (polycrystalline) seed layer that provides a (001) template is also included in prior art media.

In FIG. 4, a refractory metal seed layer 122 made of Ta-M, where M is either nitrogen or oxygen, is formed on the substrate 100. The Ta-M seed layer 122 is formed either by reactive sputtering with Ar+N₂ or Ar+O₂ gas. An underlayer 123 is deposited on this Ta-M seed layer 122. The magnetic layer 106 is formed on the underlayer 123 with a (1120) preferred orientation. A U.S. Pat. No. 5,685,958 specifies the crystallographic orientation of (002), but there is no suggestions as to the composition of the underlayer. Hence, the present inventor made investigations on Cr or Cr alloy underlayers, although no attempt has been made in the prior art on other underlayer materials such as B2 materials, for example, as will be described in the following in conjunction with the embodiments of the present invention.

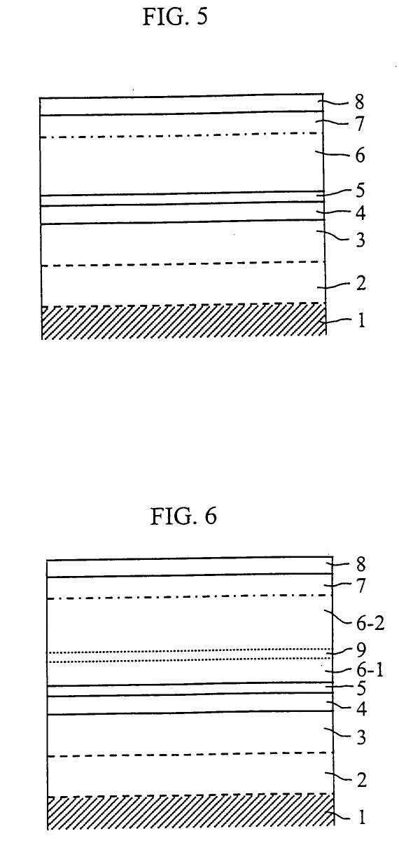

FIG. 5 is a cross sectional view showing an important part of a first embodiment of a magnetic recording medium according to the present invention, and FIG. 6 is a cross sectional view showing an important part of a second embodiment of the magnetic recording medium according to the present invention. In FIG. 6, those parts which are the same as those corresponding parts in FIG. 5 are designated by the same reference numerals, and a description thereof will be omitted.

In FIGS. 5 and 6, a seed layer 2 is formed on a glass substrate 1, and an underlayer 3 made of an intermetallic VMn alloy is formed on the seed layer 2. On the underlayer 3 is formed a magnetic layer 6 in the case of the first embodiment shown in FIG. 5, or a plurality of magnetic layers 6-1 and 6-2 that are antiferromagnetically coupled through a Ru spacer 9 in the case of the second embodiment shown in FIG. 6. The magnetic layers 6-1 and 6-2 and the Ru spacer layer 9 form a Synthetic Ferrimagnetic Media (SFM) structure.

A Cr alloy diffusion barrier layer 4 made of a material such as CrMo may be formed between the magnetic layer 6 or the SFM structure and the VMn alloy underlayer 3. In addition, an interlayer 5 may be inserted between the magnetic layer 6 or the SFM structure and the VMn alloy underlayer 3 or the Cr alloy layer 4. An overcoat layer 7 made of C and a lubricant layer 8 are successively formed on the magnetic layer 6 or the SFM structure for protection and use with a magnetic transducer such as a spin-valve head on a slider of a magnetic storage apparatus according to the present invention which will be described later.

The glass substrate 1 may be mechanically textured to promote an anisotropic distribution of the c-axes of the magnetic layer 6-1 (and 6-2) along the film plane. In addition, the seed layer 2 may be made of NiP pre-coated on the glass substrate 1. In this case, the NiP layer forming the seed layer 2 may be mechanically textured to promote an anisotropic distribution of the c-axes of the magnetic layer 6-1 (and 6-2) along the film plane.

The diffusion barrier layer 4 may be made of Cr-M and have a thickness of 1 nm to 10 nm, for example, where M is a material selected from a group consisting of Mo, Ti, V, and W of atomic proportion greater than or equal to 10%. The Cr-M diffusion barrier layer 4 desirably has a thickness of 2 nm or greater to more positively prevent the diffusion of V and Mn from the underlayer 3 into the magnetic layer 6-1.

The interlayer 5 may be made of a slightly magnetic or nonmagnetic HCP structured CoCr alloy and have a thickness of 1 nm to 5 nm, for example. When HCP magnetic CoCr alloys are grown directly on BCC Cr alloy films, a portion of the magnetic layer in contact with the BCC underlayer is adversely affected due to lattice mismatch and or Cr or VMn diffusion. Hence, in this case, the interlayer 5 can function as a diffusion barrier layer. The magnetic layer magnetic anisotropy is reduced as well as the total magnetization. The use of an HCP non-magnetic interlayer prevents such effects to happen on the magnetic layer. As a result, the magnetic anisotropy is increased as well as the coercivity, the in-plane orientation is improved as this added layer provides a way to gradually match lattice parameters, and the full magnetization is obtained, i.e., the “dead layer” is minimized. Moreover, the formation of smaller grains at the interface is also minimized.

The underlayer 3 is made of an alloy of VMn where the V content is 55 at. % to 80 at. %, and has a thickness preferably in a range of 10 nm to 30 nm. The seed layer 2 is made of a material selected from CrₓTi—O₁₀₀₋ₓ, where x=25 at. % to 60 at. % where P₀>1%, Ta—N, where a nitrogen partial pressure P_{N} relative to Ar during sputtering is 3% to 9%, or V_{y}Mn_{100-y}—N, where y=40 at. % to 80 at. % and P_{N} is at least 1%.

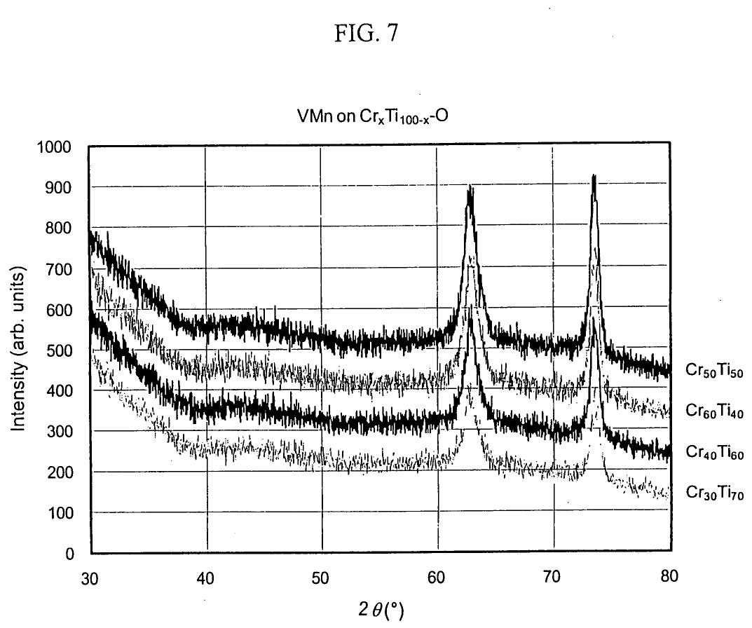

FIG. 7 shows the XRD spectra of SFM on a V₇₅Mn₂₅ (20 nm) underlayer with CrₓTi₁₀₀₋ₓ seed layers (15 nm). The seed layers were reactively sputtered in Ar+oxygen with partial pressure P₀=8%. The exact composition of the seed layers after reactive sputtering is unknown but the power for separate Cr and Ti targets were adjusted to obtain x=30, 40, 50 and 60 at. % when P₀=0%. The medium layer structure is CoCrPtB/Ru/CoCrPtB/CoCrTa/CrMo/VMn/CrTi—O/Glass. The VMn (002) texture is very good as shown by the peak near 63°. A 5 nm-thick Cr₈₀Mo₂₀ diffusion barrier layer is used and its small (002) peak causes the slight broadening on the right side of the VMn (002) peak. The excellent (002) texture results in an intense CoCrPtB (1120) peak near 73°. No (110) signature can be observed and there are also no peaks due to the Cr—Ti—O seed layers indicating their amorphous or amorphous-like nature.

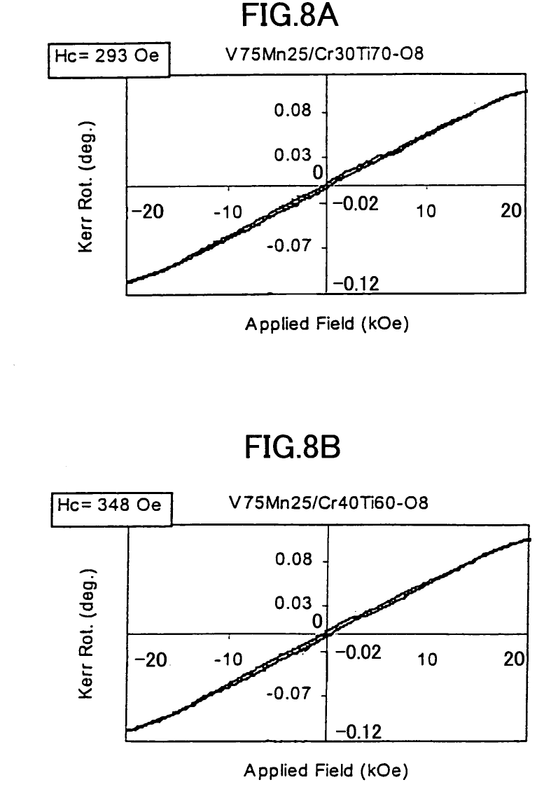

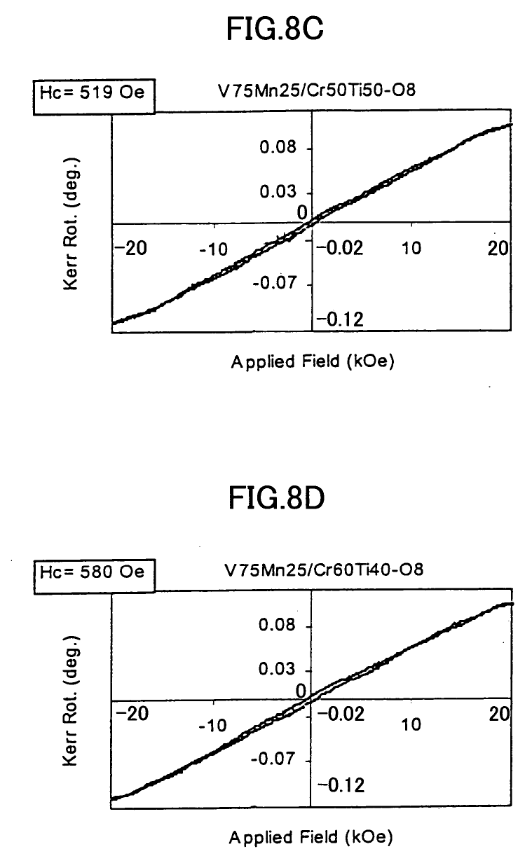

FIGS. 8A through 8D show the corresponding perpendicular hysteresis loops for x=30 at. % to 60 at. %. From FIG. 7, the most intense peaks are observed for x=50 at. % but the IPO is similar for all samples with Hc⊥ the least for x=30 at. % (293 Oe).

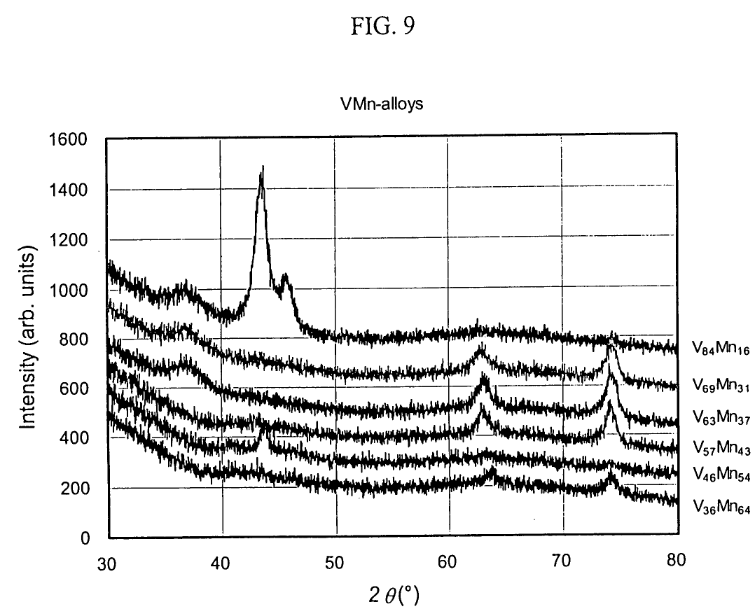

FIG. 9 shows XRD patterns for films with structure CO₆₉Cr₂₁Pt₈Ta₂ (15 nm)/Cr₈₀Mo₂₀ (5 nm)/VₓMn₁₀₀₋ₓ (20 nm)/Ta—N (25 nm) where x=36 at. % to 84 at. % on glass substrates. In FIG. 9, the ordinate indicates the intensity in arbitrary units, and the abscissa indicates 2θ (°). The intensities are shown for the VMn alloys V₈₄Mn₁₆, V₆₉Mn₃₁, V₆₃Mn₃₇, V₅₇Mn₄₃, V₄₆Mn₅₄, and V₃₆Mn₆₄. Ta deposition was made with a P_{N} of 8%, and the magnetic layer was deposited at 230° C. Peaks corresponding to VMn(110) are observed for x=46 at. % and 84 at. %.

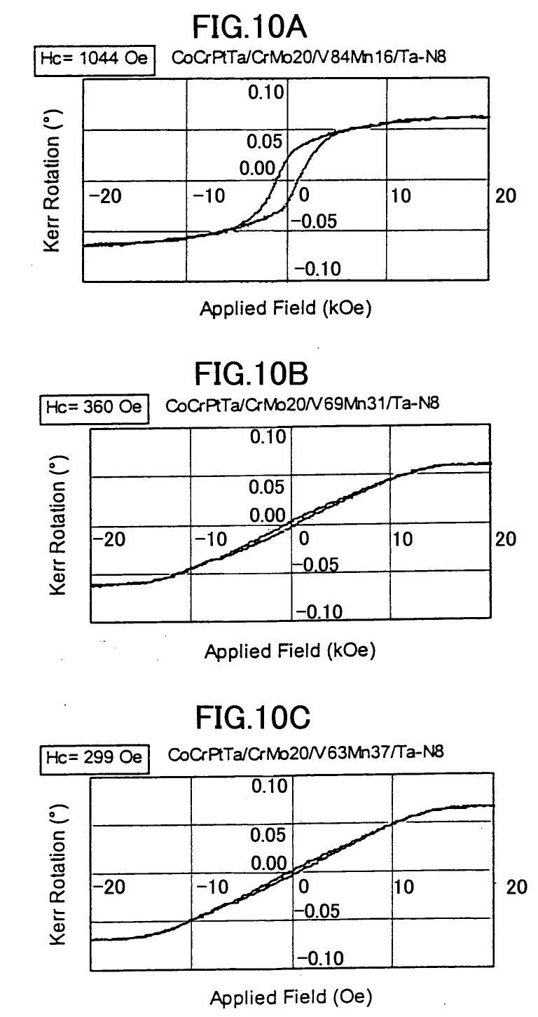

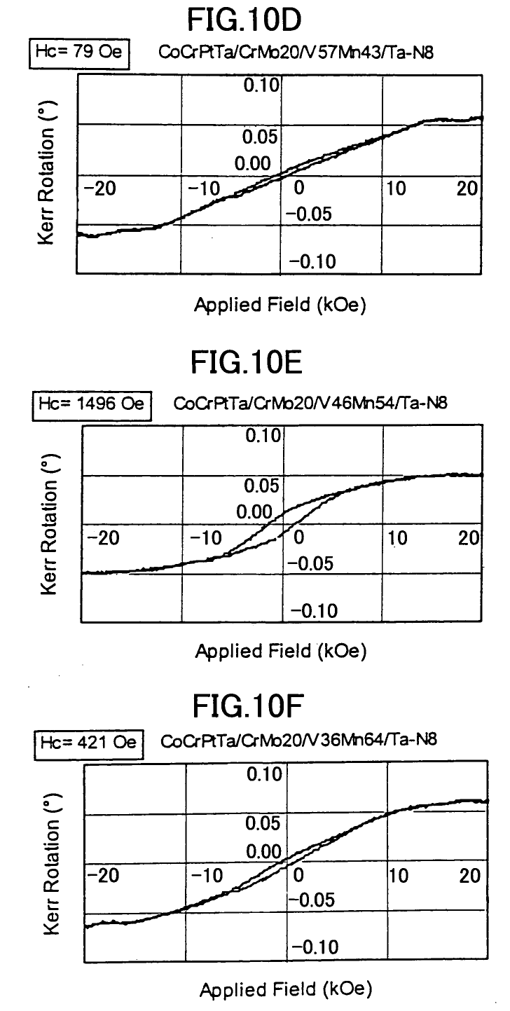

FIGS. 10A through 10F are plots showing perpendicular hysteresis loops for the film structure used in FIG. 9 measured with a Kerr magnetometer. In FIGS. 10A through 10F and FIGS. 13A through 13C, 15B, 16B and FIGS. 18A through 18D which will be described later, Hcl denotes the perpendicular coercivity. In FIGS. 10A through 10F, the ordinate indicates Kerr rotation θ (deg.), and the abscissa indicates the applied field (kOe). In FIG. 10A, Hc⊥=1044 Oe and θ=0.055. In FIG. 10B, Hc⊥=360 Oe and θ=0.065. In FIG. 10C, Hc⊥=299 Oe and θ=0.064. In FIG. 10D, Hc⊥=79 Oe and θ=0.070. In FIG. 10E, Hc⊥=1496 Oe and θ=0.045. In FIG. 10F, Hc⊥=4210e and θ=0.042. Least perpendicular coercivity Hc⊥ is exhibited by films with x=57 at. %, 63 at. %, and 74 at. %. Further investigation on a magnetic layer with boron also showed good IPO for x=51 at. %.

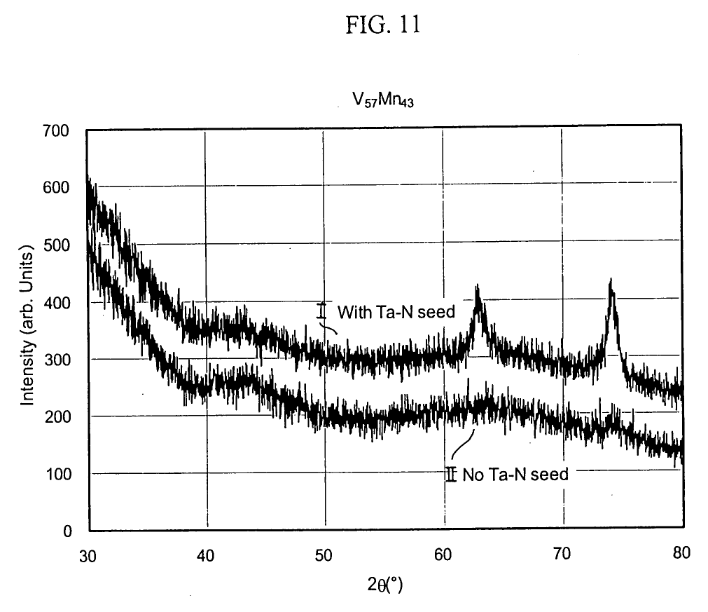

FIG. 11 shows XRD patterns for films of structure CO₆₉Cr₂₁Pt₈Ta₂ (15 nm)/Cr₈₀Mo₂₀ (5 nm)/V₇₀Mn₃₀ (20 nm) with and without a Ta—N seed layer. In FIG. 11, the ordinate indicates the intensity in arbitrary units, and the abscissa indicates 2θ (°). Spectrum I is for the structure with the TaN seed layer, and spectrum II is for the structure without the Ta—N seed layer. Peaks corresponding to VMn(002) or CrMo(002) and Co(1120) are significantly enhanced with the use of the provided seed layer. The broad peak around 2θ=28° in the lowest curve in FIG. 9 corresponds to Ta—N suggesting an amorphous structure, but this is not visible at higher substrate temperatures Ts. The seed layer is preferably 20 nm to 30 nm thick and the VₓMn₁₀₀₋ₓ underlayer is preferably 10 nm to 30 nm thick. The total thickness of the seed layer and underlayer is preferably 30 nm to 60 nm. This preferred range of thicknesses can be deposited in just two chambers and reduces the drop in substrate temperature during deposition of subsequent layers. The combination of seed layer and underlayer provided by the present invention allows a wide range of process temperatures. The seed layer can be deposited between room temperature and 300° C. and the underlayer between 100° C. and 300° C. However, since glass substrates are typically heated to at least 100° C. to promote outgassing and cleaning of the surface, the seed layer is preferably deposited at a substrate temperature Ts of Ts≧100° C. and, to prevent glass substrates from warping to temperatures, near 300° C. The VMn alloy deposited directly on glass as reported by Oh et al. exhibited better crystallographic orientation (as indicated by the XRD CoCrPt(11.0) peak intensity) at Ts=275° C. compared to that grown at Ts=200° C. Such dependence is less pronounced with the use of seed layers although high temperatures (>200° C.) are still preferred.

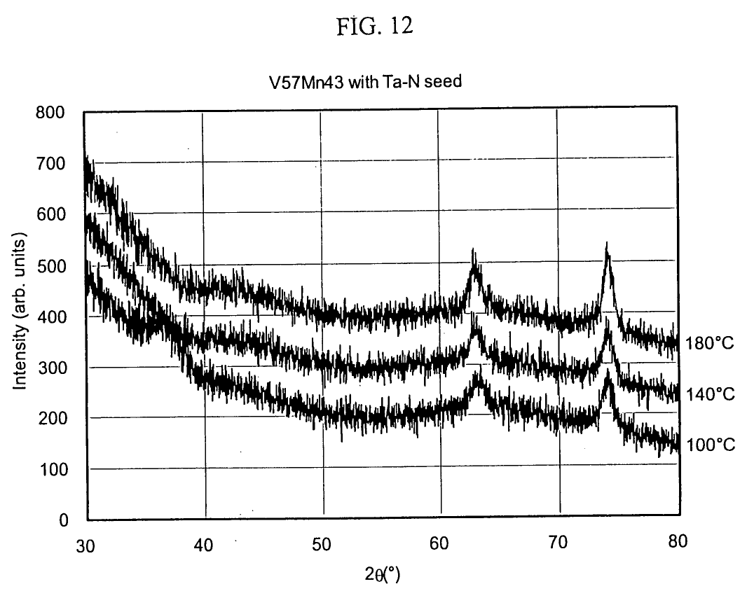

FIG. 12 shows the XRD patterns for the magnetic recording media with the structure CO₆₉Cr₂₁Pt₈Ta₂ (15 nm)/Cr₈₀Mo₂₀ (5 nm)/V₇₀Mn₃₀ (20 nm)/Ta—N (25 nm) (P_{N}=8%) grown with different heating times. The temperatures Ts of 100° C., 140° C. and 180° C. were estimated from the different heating times. In FIG. 12, the ordinate indicates the intensity in arbitrary units, and the abscissa indicates 2θ (°). As in FIG. 9, P_{N}=8% for Ta deposition and the magnetic layer deposition was at Ts=230° C. Even at low substrate temperature Ts of less than 180° C., the crystallographic orientation is better than that of using VMn without a Ta—N seed layer deposited at 240° C. as shown in FIG. 11.

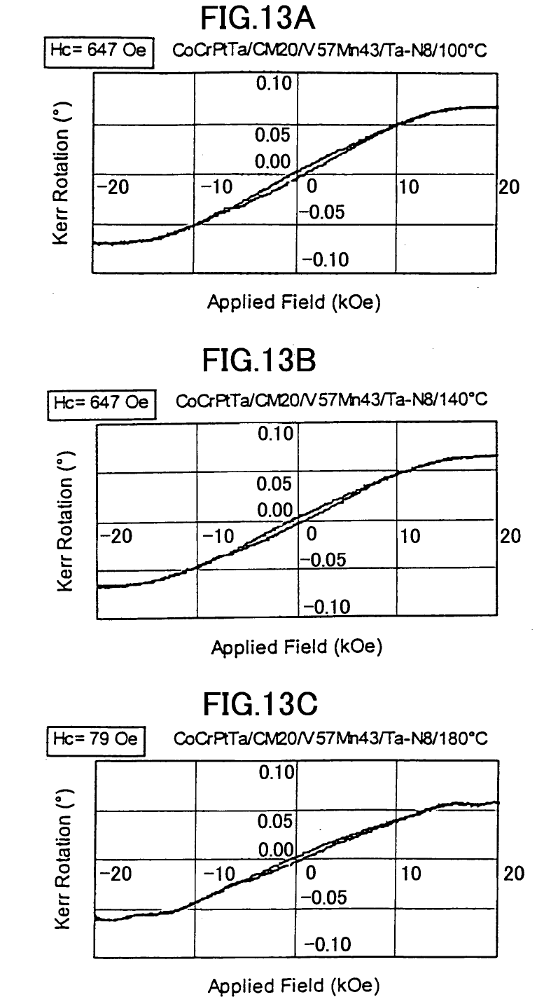

FIGS. 13A through 13C show the corresponding perpendicular hysteresis loops measured with a Kerr magnetometer. In FIGS. 13A through 13C, the ordinate indicates Kerr rotation θ (deg.), and the abscissa indicates the applied field (kOe). In FIG. 13A, Hc⊥=647 Oe and θ=0.066 at 100° C. In FIG. 13B, Hc⊥=647 Oe and θ=0.058 at 140° C. In FIG. 13C, Hc⊥=79 Oe and θ=0.070 at 180° C. Consistent with the XRD graphs, the perpendicular hysteresis loops are approximately linear with field with low Hc⊥ values.

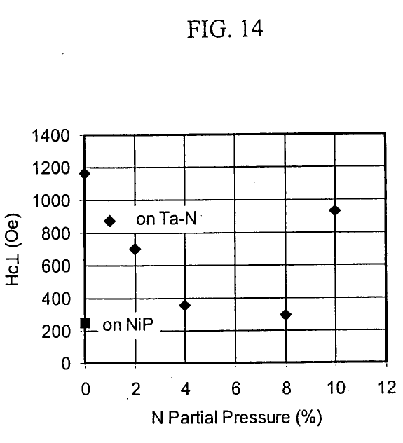

FIG. 14 shows the dependence of perpendicular coercivity Hc⊥ on the N content of Ta. In FIG. 14, the ordinate indicates the perpendicular coercivity Hc⊥ (Oe), and the abscissa indicates the N partial pressure (%). The best IPO is observed for P_{N}=2% to 8% for “♦” which indicates the data for a Ta—N seed layer and 10 nm-thick V₅₇Mn₄₃ underlayer. Although, the provided seed layers of the present invention show no distinct XRD signature, the subsequent VₓMn₁₀₀₋ₓ film deposited on any of the seed layers exhibits a (002) peak and the magnetic layer or layer structure shows a distinct (1120) texture.

Also shown in FIG. 14 are data “▪” for a Ni₈₁P₁₉ seed layer for a 10 nm-thick V₇₅Mn₃₅ underlayer. Excellent IPO is observed even at an underlayer thickness of 10 nm and was confirmed also for t=4 nm. This makes VMn alloys applicable to NiP-coated Al—Mg metal substrates but for glass substrates, since the adhesion of a sputtered NiP layer is weak, an additional adhesive layer may be necessary, requiring more process chambers, not to mention the need to either reactively sputter NiP with O₂ or oxidize its surface. However, this may be viable if NiP-plated glass substrates are available in sufficient supply.

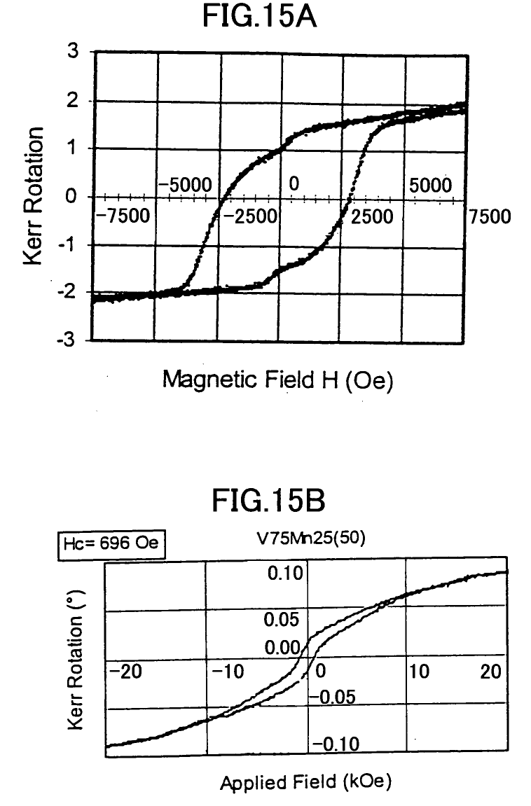

FIGS. 15A and 15B show the hysteresis loops for a two-layer SFM on a VMn underlayer in comparison to that on V₇₅Mn₂₅ with a V₇₅Mn₂₅—N6% seed layer. In FIG. 15A, the ordinate indicates the Kerr rotation θ (deg.), and the abscissa indicates the magnetic field H (Oe). In FIG. 15B, the ordinate indicates the Kerr rotation θ (deg.), and the abscissa indicates the applied field (Oe). In FIG. 15B, the structure is SFM/Cr₈₀Mo₂₀ (3 nm)/V₇₅Mn₂₅ (25 nm)/V₇₅Mn₂₅ (25 nm), and the perpendicular hysteresis loop shows Hc⊥=696 Oe and θ=0.059 at 220° C. From FIG. 15A the characteristic SFM kink is not very distinct for the media. For media with inadequate IPO, bit resolution is hardly improved over single-layer media fabricated on the same underlayer.

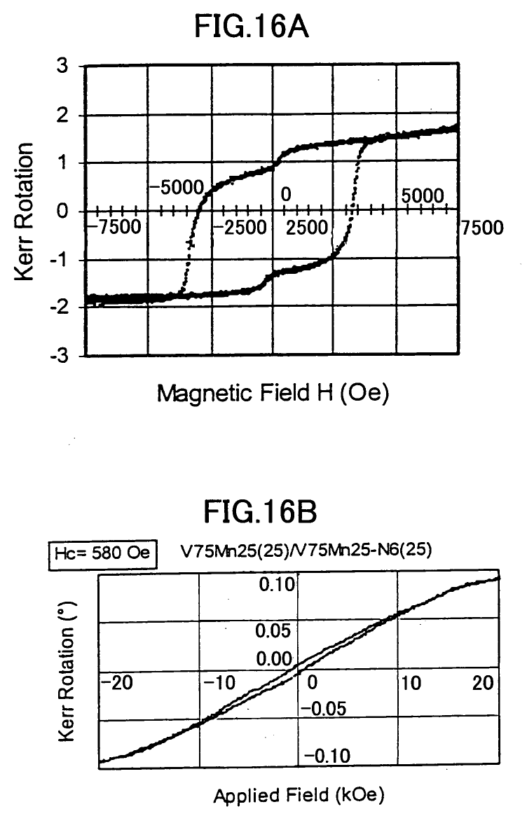

FIGS. 16A and 16B show the hysteresis loops for media on a V₇₅Mn₂₅ underlayer directly on glass in comparison to that with a V₇₅Mn₂₅—N6% seed layer. In FIG. 16A, the ordinate indicates the Kerr rotation θ (deg.), and the abscissa indicates the magnetic field H (Oe). In FIG. 16B, the ordinate indicates the Kerr rotation θ (deg.), and the abscissa indicates the applied field (Oe). For FIG. 16B, the structure is SFM/Cr₈₀Mo₂₀ (3 nm)/V₇₅Mn₂₅ (25 nm)/V₇₅Mn₂₅—N(P_{N}=6%) (25 nm), Hc⊥=580 Oe and θ=0.061 at 220° C. The medium with a V₇₅Mn₂₅—N seed layer has an Siso/Nm that is 5 dB better than the medium without the nitride seed layer. Moreover, a further improvement of +4 dB can be achieved by increasing the nitrogen partial fraction from 6% to 8%. For media with inadequate IPO, bit resolution is hardly improved over single-layer media fabricated on the same underlayer. As a consequence of IPO improvement with proper seed layers, the kink is more pronounced. Not only are media read-write properties improved but this also makes it easier to measure the exchange coupling between the magnetic layers which is very useful for mass production control.

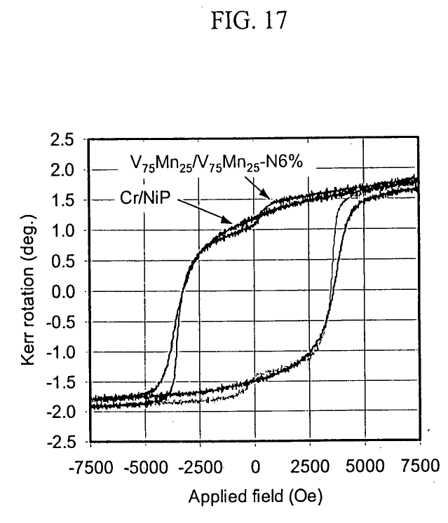

Interestingly, the magnetization of the first layer of an SFM grown on a VMn-alloy underlayer is larger than that grown on Cr/NiP. FIG. 17 shows the in-plane hysteresis loops for an SFM with the structure Co-alloy (18 nm)/Ru/Co-alloy (3 nm)/CoCr-alloy (1 nm)/CrMo (5 nm)/V₇₅Mn₂₅ (25 nm)/V₇₅Mn₂₅—N6% (25 nm)/Glass and Co-alloy (17 nm)/Ru/Co-alloy (3 nm)/CoCr-alloy (1 nm)/CrMo/CrMoW/NiP/Cr/Glass. The double Cr-alloy underlayer for the latter is for grain size and lattice parameter control. The Co-alloy used is made of Co—Cr—Pt—B—Cu and is the same for both media and all layers, yet a clear shoulder is observed only for the SFM on VMn. With VMn underlayers, near bulk properties are achieved at very low thickness values.

Much of the investigation of the present inventor was carried out with a CO₆₉Cr₂₁Pt₈Ta₂ magnetic layer which from a crystallographic viewpoint may not be so different from the CoCrPt alloy employed by Oh et al. Although magnetic layers with boron are also expected to be similar, the magnetic anisotropy is sensitive to the presesence or absence of a Cr alloy between the VMn underlayer and the magnetic layer.

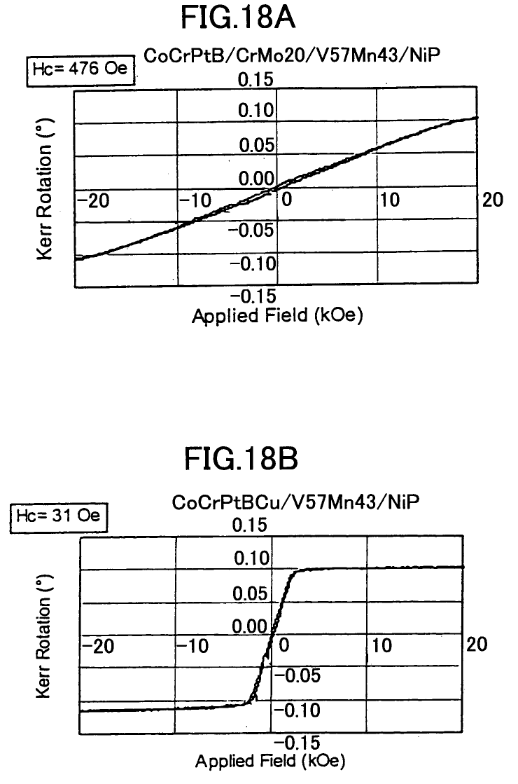

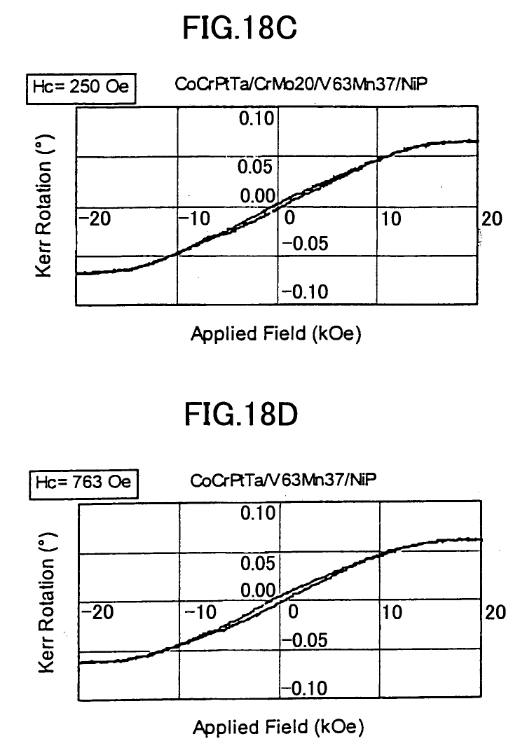

FIGS. 18A through 18D show the perpendicular hysteresis loops for CoCrPtTa and CoCrPtBCu media on VMn/NiP with and without Cr₈₀Mo₂₀. In FIGS. 18A through 18D, the ordinate indicates the Kerr rotation θ (deg.), and the abscissa indicates the applied field (Oe). Without the CrMo layer, the magnetic anisotropy H_{K} of the CoCrPtBCu media is significantly reduced. As poor lattice matching was not expected for the compositions investigated by the present inventor, it is most likely that such drastic change is most likely due to VMn diffusion into the magnetic layer. The effect may be more significant due to the smaller grains characteristic of CoCrPtB alloys compared to the CoCrPt alloy that Oh et al. has studied. In the absence of CrMo, no such behavior was observed for Co₆₉Cr₂₁Pt₈Ta₂. The IPO is also preserved indicating that such class of materials (CoCrPtTa alloys) can be good interlayers and serve as a diffusion barrier to protect magnetic layers with boron.

As VMn was not investigated in Lambeth et al., the adverse effect of VMn alloys on CoCrPtB magnetic alloys was not discovered. Moreover, Mn diffusion if any does not affect CoCtPtTa alloys as much as it affects CoCtPt (used by both Oh et al. and Lambeth et al.). CoCrTa, as pointed out in Lambeth et al., is already less influenced by Mn compared to CoCrPt.

FIGS. 18A through 18D are plots showing perpendicular hysteresis loops for the films with various structures on glass substrates measured with a Kerr magnetometer. In FIG. 18A, the structure is CoCrPtBCu/Cr₈₀Mo₂₀ (5 nm)/V₅₇Mn₄₃/NiP, Hc⊥=1044 Oe and θ=0.055. In FIG. 18B, the structure is CoCrPtBCu/V₅₇Mn₄₃/NiP, Hc⊥=360 Oe and θ=0.065. In FIG. 18C, structure is CoCrPtTa/Cr₈₀Mo₂₀ (5 nm)/V₆₃Mn₃₇/NiP, Hc⊥=299 Oe and θ=0.064. In FIG. 18D, structure is CoCrPtTa/V₆₃Mn₃₇/NiP, Hc⊥=79 Oe and θ=0.070. For example, the magnetic layer thickness is 15 nm, the VMn layer thickness is on the order of approximately 10 nm, and the NiP thickness is 25 nm in these cases.

More layers may be added to the media structure here described such as a pre-seed layer before the seed layer which although not preferred due to the increase in process chambers, may be employed. For example, we have observed that media with structure CoCrPtB/CoCr/CrMo/TaN/Glass can be improved by inserting a surface-oxidized NiP between the TaN seed layer and the glass substrate. However, in this case, media on Cr/NiP performed better (higher signal-to-noise ratio) than media on Cr/TaN/NiP but the argument stands that pre-seed layers may improve the described embodiments. There may be more seed layers known to those skilled in the art that are capable of improving the in-plane orientation of the VMn alloy here presented, the use of which does not deviate from the spirit of the present invention. Moreover, though the embodiments were made specifically for rigid glass substrates, the invention may be readily applied by those skilled in the art to other substrates such as metal, polymer, plastic, or ceramic flexible and rigid substrates and still not depart from the spirit of the present invention.

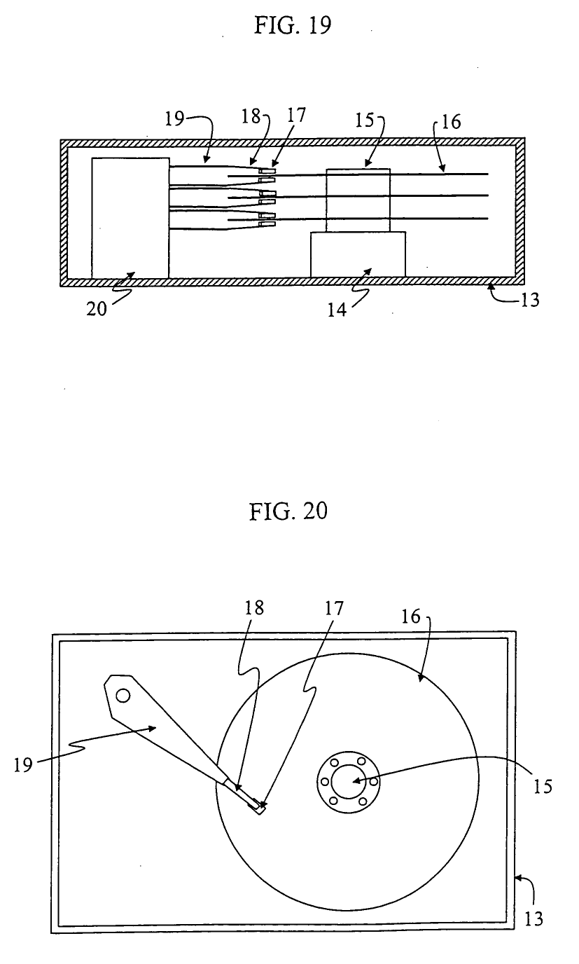

FIG. 19 is a cross sectional view showing an important part of an embodiment of the magnetic storage apparatus according to the present invention, and FIG. 20 is a plan view of the magnetic storage apparatus shown in FIG. 19 with a top cover removed.

In FIGS. 19 and 20, on a base 13 is mounted a motor 14 which turns a hub 15 on which are attached magnetic recording disks 16. Information is read by a MR (or GMR) head which is attached to a slider 17. An inductive-type head may be merged with the MR element. The slider 17 is connected to a suspension 18 which pushes the slider 17 against the disk surface. The slider surface is further patterned such that for a given disk rotation speed and suspension stiffness, the slider 17 flies at a particular height above the magnetic disk surface. The suspension 18 is in turn fixed to a rigid arm 19 which is connected to an actuator 20. This provides the ability to write over a large portion of the magnetic recording disks 16.

In this embodiment of the magnetic storage apparatus, each magnetic recording disk 16 has the structure of either one of the first and second embodiments of the magnetic recording medium described above.

Of course, the magnetic recording medium is not limited to the magnetic recording disk, and the magnetic recording medium may take a form other than a disk, such as a card and a tape.

Further, the present invention is not limited to these embodiments, but various variations and modifications may be made without departing from the scope of the present invention.

1. A magnetic recording medium comprising:
a glass substrate;
an amorphous seed layer deposited directly on said substrate;
a VₓMn₁₀₀₋ₓ underlayer where x=55 at. % to 80 at. % formed on said amorphous seed layer; and
a CoCr alloy magnetic layer disposed on said underlayer,
wherein c-axes of said magnetic layer is significantly parallel to a film plane thereof with a ratio h≦0.15, where h=Hc⊥/Hc, Hc⊥ denotes a perpendicular coercivity perpendicular to the film plane, and Hc denotes a coercivity along the film plane.

2. The magnetic recording medium according to claim 1, wherein said magnetic layer is made up of a synthetic ferrimagnetic structure having at least two antiferro-magnetically coupled CoCr alloy magnetic layers wherein c-axes of the magnetic layers are significantly parallel to the film plane such that h≦0.15.

3. The magnetic recording medium according to claim 1, wherein said underlayer has a thickness of 5 nm to 30 nm.

4. The magnetic recording medium according to claim 1, wherein said seed layer is made of CrₓTi₁₀₀₋ₓ where x=25 at. % to 60 at. % and has a thickness of 20 nm to 30 nm.

5. The magnetic recording medium according to claim 1, wherein said seed layer is made of Ta and has a thickness of 20 nm to 30 nm.

6. The magnetic recording medium according to claim 1, wherein said seed layer is made of V_{y}Mn_{100-y} where y=40 at. % to 80 at. % and has a thickness of 20 nm to 30 nm.

7. The magnetic recording medium according to claim 1, wherein a total thickness of said seed layer and said underlayer is greater than 30 nm and less than 60 nm.

8. The magnetic recording medium according to claim 1, wherein said seed layer is made of NiP pre-coated on said glass substrate.

9. The magnetic recording medium according to claim 1, further comprising:
a Cr-M layer having a thickness of 1 nm to 10 nm formed directly on said underlayer and disposed between said underlayer and said magnetic layer or synthetic ferrimagnetic structure, where M is a material selected from a group consisting of Mo, Ti, V, and W of atomic proportion greater than or equal to 10%.

10. The magnetic recording medium according to claim 1, further comprising:
an interlayer made of a slightly magnetic or nonmagnetic hcp structured CoCr alloy and having a thickness of 1 nm to 5 nm in direct contact with said magnetic layer or synthetic ferrimagnetic structure and disposed between said underlayer and said magnetic layer or synthetic ferrimagnetic structure.

11. The magnetic recording medium according to claim 1, further comprising:
a protective layer made of C and having a thickness of 1 nm to 5 nm and an organic lubricant having a thickness of 1 nm to 3 nm.

12. The magnetic recording medium according to claim 1, wherein said glass substrate is mechanically textured to promote an anisotropic distribution of the c-axes of said magnetic layer along the film plane.

13. The magnetic recording medium according to claim 8, wherein said NiP layer is mechanically textured to promote an anisotropic distribution of the c-axes of said magnetic layer along the film plane.

14. A magnetic storage apparatus comprising:
a magnetic recording medium having a glass substrate, a CoCr alloy magnetic layer, a VₓMn₁₀₀₋ₓ underlayer where x=55 at. % to 80 at. % formed on an amorphous seed layer which is formed directly on said glass substrate, wherein c-axes of said magnetic layer is significantly parallel to a film plane with a ratio h≦0.15, where h=Hc⊥/Hc, Hc⊥ denotes a perpendicular coercivity perpendicular to the film plane, and Hc denotes a coercivity along the film plane; and
a transducer to write a read data on said medium.

15. The magnetic storage apparatus according to claim 14, wherein the magnetic layer of said magnetic recording medium has a synthetic ferrimagnetic structure made up of at least two antiferromagnetically coupled CoCr alloy magnetic layers wherein c-axes of magnetic layers are significantly parallel to the film plane such that h≦0.15.

16. The magnetic storage apparatus according to claim 14, wherein the underlayer of said magnetic recording medium has a thickness of 5 nm to 30 nm.

17. The magnetic storage apparatus according to claim 14, wherein the seed layer of said magnetic recording medium is made of CrₓTi₁₀₀₋ₓ where x=20 at. % to 60 at. % and has a thickness of 20 nm to 30 nm.

18. The magnetic storage apparatus according to claim 14, wherein the seed layer of said magnetic recording medium is made of Ta of and has thickness of 20 nm to 30 nm.

19. The magnetic storage apparatus according to claim 14, wherein the seed layer of said magnetic recording medium is made of V_{y}Mn_{100-y} where y=40 at. % to 80 at. % and has a thickness of 20 nm to 30 nm.

20. The magnetic storage apparatus according to claim 14, wherein a total thickness of the seed layer and the underlayer of said magnetic recording medium is greater than 30 nm and less than 60 nm.

21. The magnetic storage apparatus according to claim 14, wherein the seed layer of said magnetic recording medium is made of NiP pre-coated on said glass substrate.

22. The magnetic storage apparatus according to claim 14, wherein said magnetic recording medium further has a Cr-M layer with a thickness of 1 nm to 10 nm formed directly on the underlayer and disposed between the underlayer and the magnetic layer or synthetic ferrimagnetic structure where M is a material selected from a group consisting of Mo, Ti, V, and W of atomic proportion greater than or equal to 10%.

23. The magnetic storage apparatus according to claim 14, wherein said magnetic recording medium further has an interlayer made of a slightly magnetic or nonmagnetic hcp structured CoCr alloy film having thickness of 1 nm to 5 nm in direct contact with the magnetic layer or synthetic ferrimagnetic structure and disposed between the underlayer and the magnetic layer or synthetic ferrimagnetic structure.
